(19) United States
(12) Patent Application Publication
(10) Pub. No.: US 2026/0061670 A1
(43) Pub. Date: Mar. 5, 2026

(54) SYSTEMS AND METHODS FOR BONDING THREE-DIMENSIONAL POLYMERIC FEATURES DIRECTLY TO A TEXTILE

(71) Applicant: NIKE, Inc., Beaverton, OR (US)

(72) Inventors: Adam J. Chang, Beaverton, OR (US); Edwin Cruz, Beaverton, OR (US); Eric J. Grimberg, Portland, OR (US); Jesse E. Handelman, Portland, OR (US); Stephan Hausmann, Happy Valley, OR (US); Nikki Kaia Lee, Portland, OR (US); Ching Fen Liao, Lake Oswego, OR (US); Fabio Marniga, Portland, OR (US); Vessela A. Yordanova, Portland, OR (US)

(73) Assignee: NIKE, Inc., Beaverton, OR (US)

(21) Appl. No.: 18/825,797

(22) Filed: Sep. 5, 2024

(51) Int. Cl. B29C 43/18; B29C 43/00; B29K 75/00; B29K 105/00; B29L 31/50

(52) U.S. Cl. CPC B29C 43/18; B29C 43/003; B29C 2043/189; B29K 2075/00; B29K 2105/251; B29K 2713/00; B29L 2031/505

(57) ABSTRACT

A method can include filling one or more recesses of a mold with a polymer, where the one or more recesses comprise a first recess that is depressed into the mold and shaped and sized according to a 3D polymeric feature to be bonded to a textile. The method can further include forming the 3D polymeric feature within the mold and arranging the textile over the 3D polymeric feature within the mold and pressing the textile and mold together to bond the 3D polymeric feature directly to a surface of the textile. The 3D polymeric feature extends outward from the surface of the textile.

### FIELD

This disclosure relates generally to articles of footwear and, in particular to systems and methods for bonding a three-dimensional polymeric feature to at least a portion of an article of footwear.

### BACKGROUND

An article of footwear typically includes two main components: a sole structure and an upper. The sole structure is configured for supporting the wearer's foot and providing cushioning between the wearer's foot and the ground. The sole structure may include an outsole that is adapted to contact the ground. The upper is coupled to the sole structure and is configured for securing the wearer's foot to the sole structure.

### SUMMARY

The foregoing and other objects, features, and advantages of the invention will become more apparent from the following detailed description, which proceeds with reference to the accompanying figures.

### BRIEF DESCRIPTION OF THE DRAWINGS

FIG. 1 is a side view of an exemplary article of footwear including an upper with a 3D polymeric feature bonded directly to a surface of the upper.

FIG. 2 is a schematic cross-sectional view of the 3D polymeric feature of FIG. 1.

FIG. 3 is a schematic cross-sectional view of a 3D polymeric feature bonded to a textile, where the 3D polymeric feature has varying thicknesses (i.e., heights) in a wave-like pattern.

FIG. 4 is a schematic cross-sectional view of a 3D polymeric feature bonded to a textile, where the 3D polymeric feature comprises a plurality of portions having a rectangular cross-sectional shape with varying thickness and widths.

FIG. 5 is a schematic cross-sectional view of a 3D polymeric feature bonded to a textile, where the 3D polymeric feature comprises a ramped region and a plurality of triangular-shaped regions.

FIG. 6 is a schematic cross-sectional view of a 3D polymeric feature bonded to a textile, where the 3D polymeric feature comprises a plurality of ramped regions and rectangular regions having varying thicknesses.

FIG. 7 is a flow chart of a method for creating 3D polymeric features directly on a wearable textile, such as an upper for an article of footwear.

FIG. 8 depicts arranging multiple layers of textile components onto a mold backing.

FIG. 9 depicts heat pressing the layers of textile components of FIG. 8 together.

FIG. 10 depicts cool pressing the layer of textile components of FIG. 8 together, following the heat press.

FIG. 11 depicts arranging a template comprising one or more openings over a mold including one or more recesses for forming a 3D polymeric feature therein.

FIG. 12 depicts filling the template and mold of FIG. 11 with polymer pellets.

FIG. 13 depicts heat pressing the filled mold to form the 3D polymeric feature within the mold.

FIG. 14 depicts removing excess polymer material from around the formed 3D polymeric feature within the mold.

FIG. 15 depicts arranging the textile of FIGS. 8-10 over the formed 3D polymeric feature and the mold.

FIG. 16 depicts heat pressing the textile and mold together in order to bond the 3D polymeric feature to the textile.

FIG. 17 depicts removing the textile with the 3D polymeric feature bonded thereto from the mold.

FIG. 18 depicts the finished textile with the 3D polymeric feature bonded to a surface of the textile, where the textile is a portion of an upper for an article of footwear.

FIG. 19 depicts an exemplary textile for an upper of an article of footwear, the textile comprising 3D polymeric features bonded thereto.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed examples, alone and in various combinations and subcombinations with one another. For example, any features or aspects of the disclosed examples can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” or “secured” encompasses mechanical and chemical couplings, as well as other practical ways of coupling or linking items together and does not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For purposes of this disclosure, portions of an article of footwear (and the various component parts thereof) may be identified based on regions of the foot located at or near that portion of the article of footwear when the footwear is worn on the properly sized foot. For example, an article of footwear and/or a sole structure may be considered as having a “forefoot region” at the front of the foot, a “midfoot” region at the middle or arch area of the foot, and a “heel region” at the rear of the foot. Footwear and/or sole structures also include a “lateral side” (the “outside” or “little toe side” of the foot) and a “medial side” (the “inside” or “big toe side” of the foot). The forefoot region generally includes portions of the footwear corresponding to the toes and the joints connecting the metatarsals with the phalanges. The midfoot region generally includes portions of the footwear corresponding with the arch area of the foot. The heel region generally corresponds with the rear portions of the foot, including the calcaneus bone. The lateral and medial sides of the footwear extend through the forefoot, midfoot, and heel regions and generally correspond with opposite sides of the footwear (and may be considered as being separated by a central longitudinal axis). These regions and sides are not intended to demarcate precise areas of footwear. Rather, the terms “forefoot region,” “midfoot region,” “heel region,” “lateral side,” and “medial side” are intended to represent general areas of an article of footwear and the various components thereof to aid the in discussion that follows.

For purposes of this disclosure, directional adjectives may be employed which correspond to the illustrated example. For example, the term “longitudinal” as used herein refers to a direction extending a length of an article. In some cases, the longitudinal direction may extend from a forefoot portion to a heel portion of the article. Also, the term “lateral” as used herein refers to a direction extending a width of an article. In other words, the lateral direction may extend between a medial side and a lateral side of an article. Furthermore, the term “vertical” as used herein refers to a direction generally perpendicular to a lateral and longitudinal direction. For example, in cases where an article is planted flat on a ground surface, the vertical direction may extend from the ground surface upward. It will be understood that each of these directional adjectives may be applied to individual components of an article, such as an upper and/or a sole structure.

As used herein, the term “exemplary” means serving as a non-limiting example, instance, or illustration. As used herein, the terms “e.g.,” and “for example,” introduce a list of one or more non-limiting examples, instances, and/or illustrations.

As used herein, the term “sole structure” refers to any combination of materials that provides support for a wearer's foot and bears the surface that is in direct contact with the ground or playing surface, such as, for example, a single sole; a combination of an outsole and an inner sole; a combination of an outsole, a midsole, and an inner sole; and a combination of an outer covering, an outsole, a midsole and an inner sole.

As used herein, the terms “attached” and “coupled” generally mean physically connected or linked, which includes items that are directly attached/coupled and items that are attached/coupled with intermediate elements between the attached/coupled items, unless specifically stated to the contrary.

As used herein, the terms “articles of footwear” or “articles” mean any type of footwear, including, for example, basketball shoes, volleyball shoes, tennis shoes, running shoes, soccer shoes, football shoes, rugby shoes, baseball shoes, sneakers, hiking boots, sandals, socks, etc.

Although the figures may illustrate an article of footwear intended for use on only one foot (e.g., a right foot) of a wearer, one skilled in the art and having the benefit of this disclosure will recognize that a corresponding article of footwear for the other foot (e.g., a left foot) would be a mirror image of the right article of footwear.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, claims, abstract, and drawings.

### THE DISCLOSED TECHNOLOGY

An article of footwear typically includes two main components: a sole structure and an upper. The sole structure is configured for supporting the wearer's foot and providing cushioning between the wearer's foot and the ground (e.g., the surface on which they are moving, walking, running, etc.). The upper is coupled to the sole structure and forms a foot-receiving cavity. The upper is configured for securing the wearer's foot to the sole structure and/or can protect the wearer's foot.

In some examples, it may be desirable to create a three-dimensional (3D) feature or features on a textile, such as a wearable textile. As defined herein, a “wearable textile” can refer to a textile that is worn by a user, and as a result, experiences enhanced motion (e.g., bending, pulling, pressure, or the like) as compared to a stationary textile.

In some examples, the wearable textile is a portion of an upper of an article of footwear. In some examples, the wearable textile is a portion of a sole structure of an article of footwear. In some examples, the wearable textile is a portion of a sports bra, sock, glove, hat, shirt, shorts, elbow pad, or the like.

The 3D feature can provide an enhanced appearance that may be desired by a wearer and/or provide enhanced stability and containment to the wearer's foot. However, such 3D features can be difficult and time consuming to create on a textile, such as the upper for the article of footwear. As one example, bonding between a polymeric material for creating the 3D features and the textile can be difficult, particularly for wearable textiles that fold, stretch, and otherwise move with movement of the wearer (e.g., the wearer's foot).

Described herein are methods and systems for creating 3D polymeric features directly on a textile. In some examples, the textile is a wearable textile, such as an upper for an article of footwear. In some examples, the 3D polymeric feature comprises a polymer that is cured on and bonded to the textile. The method can produce 3D polymeric features comprising raised features of varying heights (in a direction away from a surface of the textile, which can also be referred to herein as thicknesses).

In some examples, the method includes creating a mold shaped according to the textile and having a recess shaped and sized according to the 3D polymeric feature or features to be created on the textile. The recess of the mold can be filled with polymeric pellets (or polymer of another form) which are heated and cooled within the mold. The textile can then be arranged over the mold and the assembly can be pressed at specified temperatures to transfer and bond the 3D polymeric feature(s) to the textile. The textile can then be assembled with a remainder of the article, such as assembling the upper to a sole member of the article of footwear.

In this way, 3D features (e.g., 3D polymeric features) can be directly bonded to a textile without stitching. This can increase the ease and efficiency of the process of manufacturing the article. Additionally, this process can create a wide variety of 3D features which are visually appealing to a wearer. By adjusting heights (or thicknesses) of the 3D features in different regions of the article, the boding of the 3D feature to the textile, as well as the overall durability of the 3D feature on the textile, can be improved. In some examples, the contours and/or shapes of the 3D features(s) can be integrated with additional articles of the upper, such as a midsole, thereby creating a continuous 3D shape on the article that can be visually appealing and/or enhance stability and containment for the resulting article.

In some examples, a method comprises filling one or more recesses of a mold with a polymer, wherein the one or more recesses comprise a first recess that is depressed into the mold and shaped and sized according to a 3D polymeric feature to be bonded to a textile. The method further comprises forming the 3D polymeric feature within the mold, and arranging the textile over the 3D polymeric feature within the mold and pressing the textile and mold together to bond the 3D polymeric feature directly to a surface of the textile. The 3D polymeric feature extends outward from the surface of the textile.

In some examples, an upper for an article of footwear comprises a textile comprising a first side surface configured to bond with a polymeric material, and a 3D polymeric feature bonded directly to the first side surface without fasteners. The 3D polymeric feature comprises at least a first portion with a first thickness and first opacity and a second portion with a second thickness and second opacity. The first thickness and first opacity are greater than the second thickness and second opacity. The first and second thicknesses are defined in a direction extending outward and away from the first side surface of the textile.

In some examples, a method for forming an upper of an article of footwear comprises preparing a textile for the upper and filling one or more recesses of a mold with a solid polymer, where the one or more recesses comprise a first recess that is depressed into the mold and shaped and sized according to a 3D polymeric feature to be bonded to the prepared textile. The method further comprises forming the 3D polymeric feature within the first recess of the mold, bonding the 3D polymeric feature directly to a surface of the prepared textile, and removing the textile from the mold. The 3D polymeric feature extends outward from the surface of the textile. The method further comprises assembling the textile with one or more additional components to form the upper.

In some examples, a wearable textile comprises a woven fabric with a first side surface configured to bond with a polymeric material and a 3D polymeric feature bonded directly to the first side surface without fasteners. The 3D polymeric feature comprises at least a first portion with a first thickness and first opacity and a second portion with a second thickness and second opacity. The first thickness and first opacity are greater than the second thickness and second opacity. The first and second thicknesses are defined in a direction extending outward and away from the first side surface of the textile.

Additional examples of the disclosed technology are described below with reference to the accompanying drawings.

### Examples of the Disclosed Technology

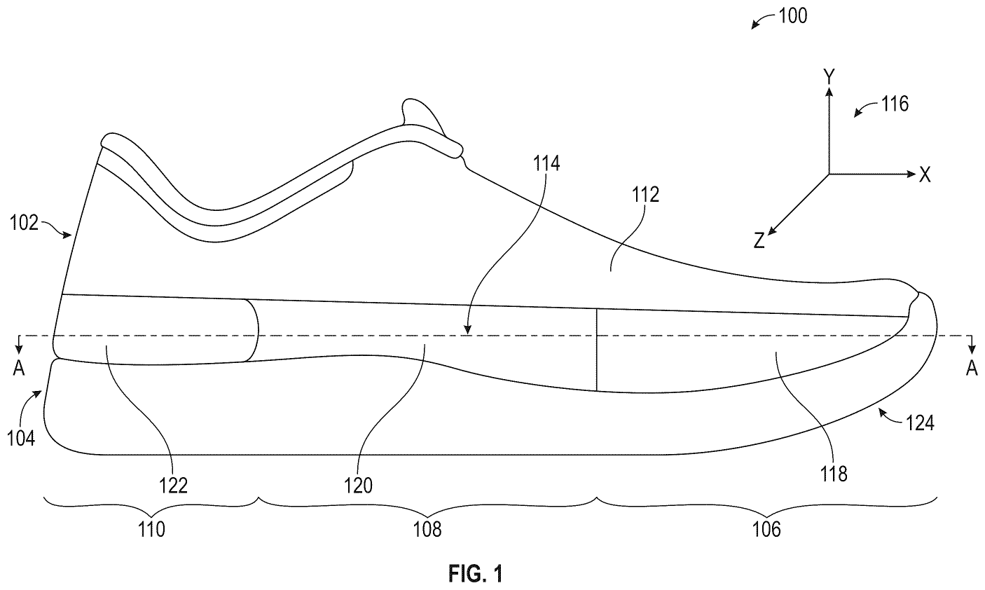

FIG. 1 shows an article of footwear which can also be referred to simply as the article 100. The article 100 comprises an upper 102 and a sole structure 104.

For purposes of reference, the article 100 can be divided into a forefoot portion 106, a midfoot portion 108, and a heel portion 110. In addition, the article 100 may include a lateral side (the side shown in FIG. 1) and a medial side (the side arranged opposite the lateral side). Both the lateral side and the medial side may extend through the forefoot portion 106, midfoot portion 108, and heel portion 110.

The sole structure 104 is secured to the upper 102 and extends between the foot and the ground when the article 100 is worn by an individual. In different examples, the sole structure 104 can include different components. For example, the sole structure 104 can include an outsole, a midsole, and/or an insole. In some cases, one or more of these components may be optional.

In some examples, when the sole structure 104 comprises an outsole, the outsole can be configured with one or more traction surfaces and/or can be configured to cover and/or protect at least a portion of the midsole and/or the upper.

In some examples, when the sole structure 104 comprises a midsole, the midsole can be disposed between the upper 102 and the outsole and can be configured to provide cushioning.

The sole structure 104 may provide one or more functions for the article 100. For example, in some examples, the sole structure 104 may be configured to provide traction for the article 100. In addition to providing traction, the sole structure 104 may attenuate ground reaction forces when compressed between the foot and the ground during walking, running or other ambulatory activities. The configuration of the sole structure 104 may vary in different examples to include a variety of conventional or non-conventional structures. In some cases, the configuration of the sole structure 104 can be selected according to one or more types of ground surfaces on which the sole structure 104 may be used. Examples of ground surfaces include, but are not limited to natural turf, synthetic turf, dirt, cement, as well as other surfaces.

The article 100 may be configured for use with various kinds of footwear including, but not limited to: hiking boots, soccer shoes, football shoes, sneakers, running shoes, cross-training shoes, rugby shoes, basketball shoes, baseball shoes as well as other kinds of shoes. Moreover, in some examples the article 100 may be configured for use with various kinds of non-sports related footwear, including, but not limited to: slippers, sandals, high heeled footwear, loafers as well as any other kinds of footwear, apparel and/or sporting equipment (e.g., gloves, helmets, etc.).

Generally, the upper 102 may be any type of upper. In particular, the upper 102 may have any design, shape, size and/or color. For example, in examples where the article 100 is a basketball shoe, the upper 102 could be a high-top upper that is shaped to provide high support on an ankle. In examples where the article 100 is a running shoe, the upper 102 could be a low top upper.

In some examples, the upper 102 includes provisions for fastening the article 100 to a foot, such as a lacing region.

In some examples, the upper 102 can be coupled to the sole structure 104 (e.g., via a strobel), thereby forming a foot-receiving cavity between the sole structure 104 and the upper 102. For example, the upper 102 may include one or more material elements (for example, textiles, foam, leather, and synthetic leather), which may be stitched, adhesively bonded, molded, or otherwise formed to define an interior void configured to receive a foot.

In some examples, at least a portion of the upper, such as the side portion 112 shown in FIG. 1, can comprise a textile. The textile can comprise various materials and compositions. In some examples, the textile can comprise a woven fabric.

In some examples, the textile comprises a plurality of polymer-based yarns that are woven together.

In some examples, the textile can comprise a knitted fabric.

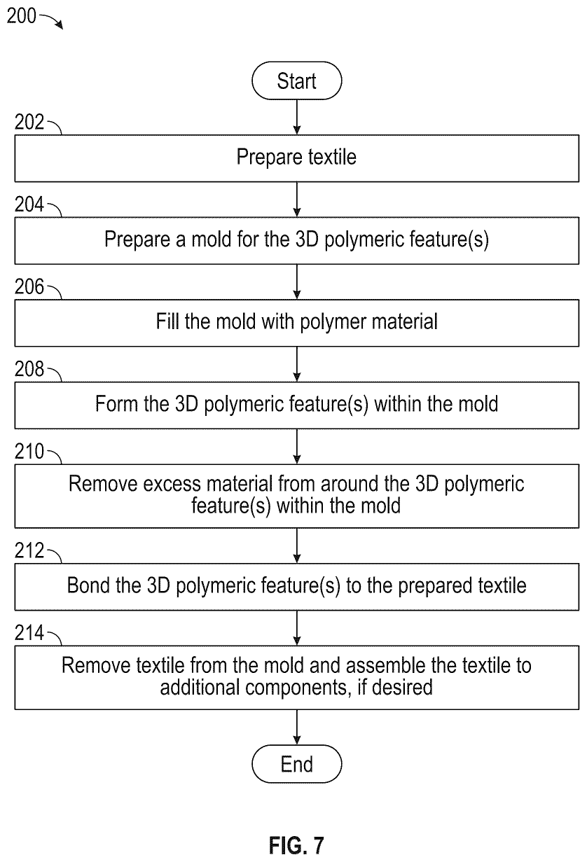

Further details on a fabric for an upper or another wearable textile are described below with reference to FIG. 7.

The article 100 includes an exemplary 3D polymeric feature 114 having at least two regions or portions of varying thickness (in a z-direction, as depicted by the coordinate axes 116). In particular, as shown in FIG. 1, the 3D polymeric feature 114 comprises a first portion 118 extending along the forefoot portion 106 of the article 100, a second portion 120 extending mostly along the midfoot portion 108 of the article 100, and a third portion 122 extending along the heel portion 110 of the article 100.

In some examples, a first thickness (in the z direction, which is out of the page in FIG. 1) of the first portion 118 is smaller than a third thickness of the third portion 122.

In some examples, the first thickness of the first portion 118 is smaller than both the third thickness of the third portion 122 and a second thickness of the second portion 120.

In some examples, the third thickness of the third portion 122 is greater than the second thickness of the second portion 120.

In some examples, the article 100 can include more or less than three portions having varying thickness (e.g., two, four, five, or the like). In some examples, a thickness of the 3D polymeric feature 114 can vary along a length of the 3D polymeric feature 114 such that the thickness increases from a minimum value at a first end (e.g., at the forefoot portion 106 or a toe region 124 of the article 100) of the 3D polymeric feature 114 to a maximum value at an opposite, second end (e.g., at the heel portion 110) of the 3D polymeric feature 114.

The length is defined in a toe-to-heel direction of the article 100 (axis A-A extends along the toe-to-heel direction, which is the x direction of the coordinate axes 116). The toe-to-heel direction is perpendicular to a medial-to-lateral direction of the article 100.

In some examples, as described further herein, having a smaller thickness at forefoot portion 106 of the article 100 (as compared to the heel portion 110 and/or midfoot portion 108) can enhance bonding of the 3D polymeric feature 114 to the textile of the side portion 112. For example, by making the 3D polymeric feature thinner in regions of the article 100 that experience enhanced bending or movement (e.g., at the forefoot portion 106), bonding of the 3D polymeric feature 114 directly to the textile of the side portion 112 can be enhanced.

The opacity of one or more regions or portions of the 3D polymeric feature is based on the thickness of that region or portion. For example, portions having a smaller thickness (such as the first portion 118) can be less opaque (or more transparent) that portions having a larger thickness (such as the third portion 122). In this way, varying visual features can be created by varying the thickness of the 3D polymeric feature 114.

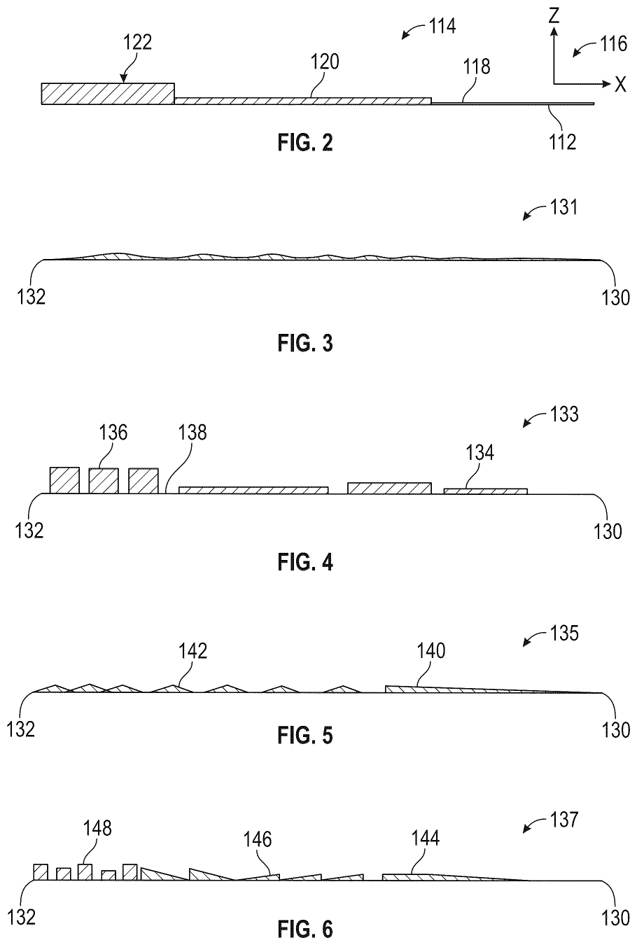

The 3D polymeric feature 114 can have various shapes, sizes, patterns, opacities, and/or the like. Examples of 3D features having regions or portions with varying shapes, patterns, thicknesses (and thus opacities), and the like, are shown in the schematic cross-sectional views of FIGS. 2-6.

It should be noted that the thicknesses of the portions or regions of the 3D polymeric features shown in FIG. 2-6 may be exaggerated for the purpose of illustration and may not be drawn to scale.

FIG. 2 depicts a first cross-sectional view taken along line A-A in FIG. 1. As seen in FIG. 2, the first thickness of the first portion 118 is smaller than the second thickness of the second portion 120, which is smaller than the third thickness of the third portion 122.

In some examples, the thickness within each of the first, second, and third portions 118, 120, and 122 can vary in the x and/or y directions.

FIGS. 3-6 show alternative thickness profiles for a 3D polymeric feature bonded to a wearable textile, such as the side portion 112 of the article 100. Thus, in some examples, any one of the 3D polymeric features shown in FIGS. 3-6 can replace the 3D polymeric feature 114 in the article 100. Further, one or more features of the 3D polymeric features in FIGS. 2-6 can be combined to define a 3D polymeric feature for the article 100 having a different arrangement of sizes, shapes, thicknesses, patterns, and/or the like.

In some examples, as shown in FIG. 3, a 3D polymeric feature 131 can have a wave-like shape that increases in thickness from a first end 130 to a second end 132 of the 3D polymeric feature. In some examples, the first end 130 can be arranged at the forefoot portion of the article.

In some examples, as shown in FIG. 4, a 3D polymeric feature 133 can comprise a plurality of portions having a rectangular cross-sectional shape with varying heights (i.e., thicknesses in the z direction) and widths (in the x direction). For example, the 3D polymeric feature 133 shown in FIG. 4 has thinner and wider rectangular regions 134 closer to the first end 130 and thicker and narrower rectangular regions 136 closer to the second end 132. In some examples, as shown in FIG. 4, the rectangular regions 134, 136 of the 3D polymeric feature 133 can be spaced apart by thinner or zero thickness regions 138 of the 3D polymeric feature 133.

As shown in FIG. 5, in some examples, a 3D polymeric feature 135 can comprise a ramped region 140 that continuously increases in thickness from the first end 130 (or a location proximate to the first end 130) toward the second end 132. The 3D polymeric feature 135 shown in FIG. 5 further comprises a plurality of triangular-shaped regions 142, where the peak of each triangular-shaped region 142 is the maximum thickness of that region.

The 3D polymeric feature 137 of FIG. 6 also includes a ramped region 144 closer to the first end 130 than the second end 132. The ramped region 144 increases in thickness for a portion and then has a constant thickness at an end portion of the ramped region 144. The 3D polymeric feature 137 of FIG. 6 also includes a plurality of triangular of smaller ramped regions 146 and a plurality of rectangular regions 148 with varying thicknesses.

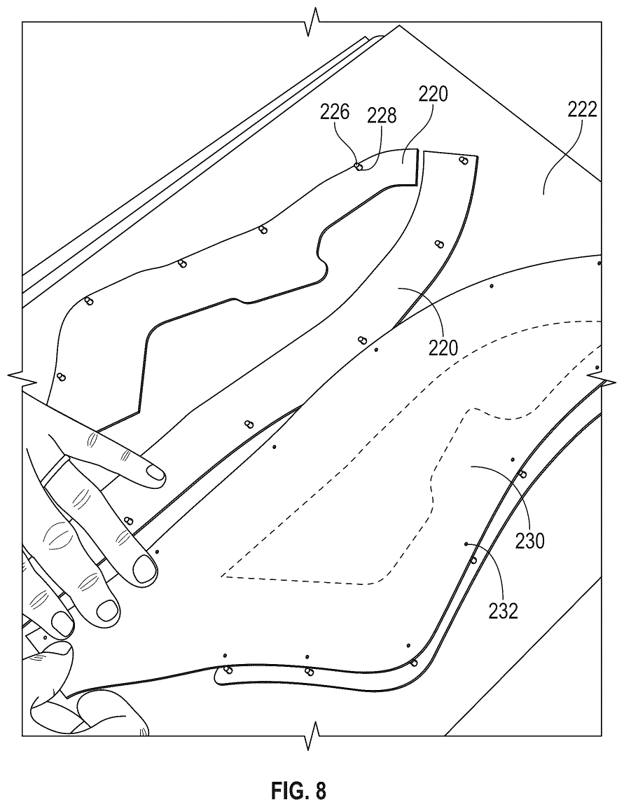

FIG. 7 shows a method 200 for creating 3D polymeric features directly on a wearable textile, such as an upper for an article of footwear. For example, the method 200 can be referred to as a “no sew process” where the 3D polymeric feature is bonded directly to a wearable textile, without any other means of fixation (e.g., stitching). The method 200 is discussed below with reference to the example shown in FIGS. 8-18. However, the method 200 can be applied to differently shaped components, molds, textiles, and/or the like.

For example, the method 200 can be used for bonding a 3D polymeric feature to a variety of different textiles and/or articles, such as textiles for hats, scarfs, shirts, pants, gloves, socks, sports bras, jackets, and the like.

One or more steps of method 200 shown in FIG. 7 can be omitted. For example, the method at 202, as described below, may not be included in the method 200 if a textile need not be prepared (e.g., it was previously prepared or cut to a desired size). As another example, the method at 204 may not be included in the method 200. For example, a template may not be placed over the mold and/or the mold may not need to be prepared prior to filling.

At 202, the method includes preparing the textile configured to receive one or more 3D polymeric features. The textile can comprise various materials, such as a knit or woven fabric.

In some examples, the textile comprises a woven polyester fabric.

In some examples, the textile comprises a weave of two or more yarns. In such examples, a first yarn of the two or more yarns can be a polyester filament. In some examples, a second yarn of the two or more yarns can be a spun or drawn textured yarn.

In some examples, the textile is coated with a layer or coating that increases bonding consistency. For example, a first or “no-sew” side surface of the textile can include an outer coating that is configured to increase bonding to the 3D polymeric feature, as described further below. In some examples, the coating comprises polyurethane.

In some examples, the coating is sprayed onto and then rolled on the textile (which may comprise a woven fabric, in some instances).

Thus, in some examples, the method at 202 includes applying a coating to one side of the textile.

In some examples, the method at 202 includes cutting a material (e.g., a fabric) into a desired shape and size for the textile to be produced. In some examples, one or more layers of material having different shapes or sizes can be cut, or otherwise prepared, for bonding to one another to form the final textile configured to receive the 3D polymeric feature(s) thereon.

In some examples, preparing the textile at 202 can include arranging one or more textile components onto a mold backing. The one or more textile components can be shaped according to at least a portion of the wearable textile that is configured to have the 3D polymeric feature bonded thereto. In some examples, the one or more textile components can comprise one or more edge pieces sized to follow a perimeter of the wearable textile and a main textile component that has the final shape of the textile and overlays the edge pieces.

In some examples, the main textile component can have two sides (or surfaces), one of which is the “no-sew” side which is manufactured such that the polymer of the 3D polymeric feature can bond thereto, as described above and further below. For example, as described above, in some instances one side of the textile can comprise a coating configured to enhance bonding.

For example, as shown in FIG. 8, edge pieces 220 are arranged onto a mold backing 222. The edge pieces 220 are shaped according to a shape of the final textile to receive the 3D polymeric feature, which in this example are textiles 268 and 270 (shown in FIG. 15) for medial and lateral sides of an upper of an article of footwear. As shown in FIG. 8, edge pieces 220 for each of the two textiles 268, 270 can be arranged on the same mold backing 222.

In some examples, as shown in FIG. 8, the mold backing 222 can comprise a plurality of pegs 226 (which can also be referred to as protrusions) and the edge pieces 220 can comprise a plurality of corresponding apertures 228 that are fit over the pegs 226. As a result, the edge pieces 220 are held in place against the mold backing 222. This can reduce or eliminate shifting of the textile components on the mold backing 222 during the process of bonding a 3D polymeric feature to the textile.

FIG. 8 shows a main textile component 230 be arranged over the edge pieces 220 of one of the sides of the upper, such that the main textile component 230 completely covers the edge pieces 220. In some examples, the main textile component 230 can comprise apertures 232 that fit over the pegs 226 of the mold backing 222.

In some examples, the main textile component 230 and the edge pieces 220 can comprise different materials.

For example, in some examples, the main textile component 230 can be a woven polyester fabric and the edge pieces 220 can comprise a knit fabric or a woven fabric of a different material.

Preparing the textile at 202 can further include inserting the assembled textile components into a pressing apparatus (e.g., a heat press or cool press) and pressing the layers together. In some examples, the pressing at 204 can include a heat press operation, followed by a cool press operation (e.g., two sequential pressing actions at different temperatures). The pressing operations can bond the textile components to one another, thereby forming the final textile(s) to which one or more 3D polymeric features can be bonded (e.g., to the no-sew side of the textiles) without sewing. In this way, a multi-layer textile can be formed without attaching the layers together via sewing or other mechanical fastening means.

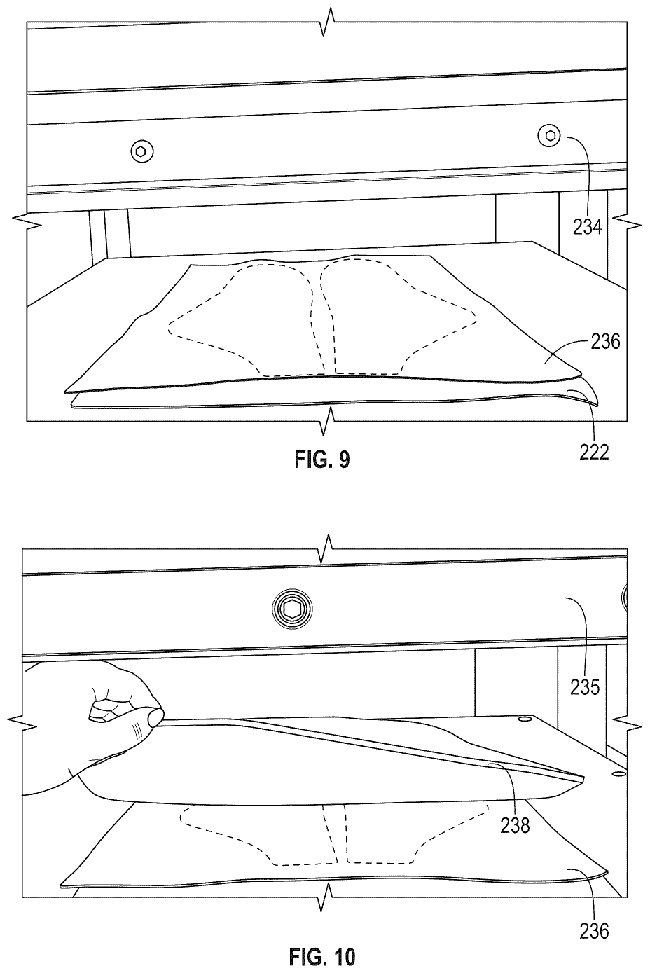

For example, as shown in FIG. 9, the textile components assembled on the mold backing 222 are arranged within a first pressing apparatus 234 that is configured to apply a pressing force to the assembled layers. One or more silicone layers 236 can be arranged over the top-most textile components (e.g., main textile components 230) inside the first pressing apparatus 234 to avoid direct contact of the textile components with the pressing apparatus 234. In FIGS. 9 and 10, the dashed lines show the outline of the underlying textile components, for the purpose of illustration.

In some examples, the silicone layers 236 can comprise 1 mm silicone and 10 mm of silicone foam.

The pressing at 202 can include applying heat with the first pressing apparatus to the assembled layers that is in range of 70-195° C.

In some examples, the pressing at 202 can include pressing together the layers a second time, at a lower temperature that during the heat press. For example, as shown in FIG. 10, the assembled components on the mold backing 222 can be arranged within a second pressing apparatus 235 (which can be referred to as a “cool press”) and the layers can be pressed together at a cooler press temperature, which can be in a range of 12-22° C.

In some examples, prior to the second, cooler pressing operation at 202, one or more silicone layers can be arranged over the first silicone layer 236. In some examples, as shown in FIG. 10, a silicone layer 238 can comprise 1 mm silicone and 5 mm of silicone foam.

At 204, the method includes preparing a mold for the 3D polymeric feature. The mold can comprise one or more cavities or recesses that can have varying patterns, textures, and depths and that are configured to receive a polymeric material, such as solid polymeric pellets. In this way, the mold can comprise cavities or recesses that are shaped according to the size, shape, texture, and/or depths (which corresponds to thickness) of the 3D polymeric feature to be created.

In some examples, the mold can comprise acrylic.

In some examples, the method at 204 can additionally include placing a template over the mold. The template can be a top plate that has an opening sized to match the shape and/or size of the recess or recesses of the mold. As such, the template can serve as a guide for the polymeric material, as described further below. In some examples, a thickness of the template is specified based on a desired thickness of the polymer material in the recess or recesses of the mold.

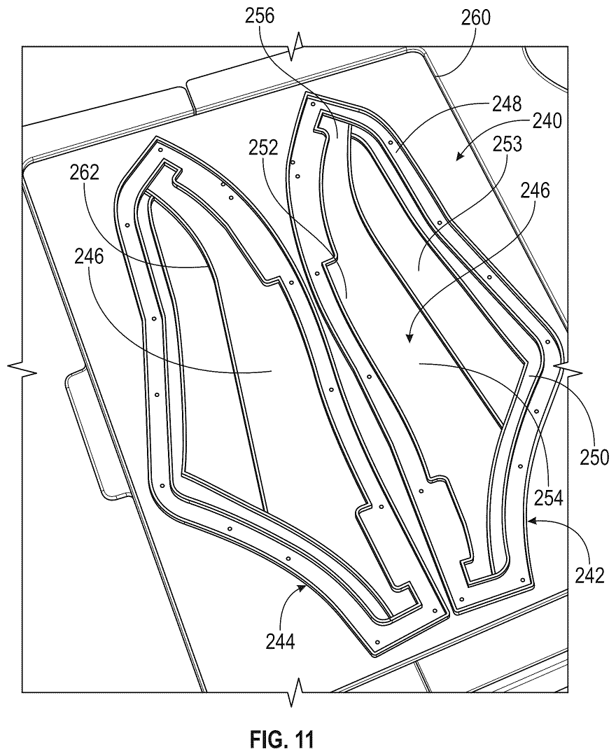

For example, as shown at FIG. 11, a mold 240 including a first mold portion 242 for a first side of an upper (e.g., a medial side) and a second mold portion 244 for a second side of the upper (e.g., a lateral side) is arranged on a prep surface. In some examples, the first mold portion 242 and second mold portion 244 may not be combined into one mold 240, and instead may be separate molds (e.g., first mold portion 242 and second mold portion 244).

Each of the first mold portion 242 and the second mold portion 244 can include a recess 246 that is depressed into the respective first mold portion 242 or second mold portion 244 from raised portions or edges of the respective first mold portion 242 or second mold portion 244. The raised portions or edges can have varying heights.

For example, as shown in FIG. 11, the first mold portion 242 can comprise a topline edge 250 that is raised relative to the recess 246.

The first mold portion 242 can also include an outermost edge 248 that extends around and defines a perimeter of the first mold portion 242. The outermost edge 248 can be depressed into the first mold portion 242 relative to the topline edge 250 and permitter regions of the recess 246.

The first mold portion 242 can also comprise an inner cavity 253 that is located between the recess 246 and the topline edge 250 and is depressed into the first mold portion 242 relative to the topline edge 250 and permitter regions of the recess 246.

The recess 246 can have varying depths along its length and/or width (for example, as depicted in the examples of FIGS. 2-6). The depths of the recess correspond directly to thicknesses of the 3D polymeric feature created in the recess 246.

In some examples, the recess 246 can comprise a pattern or texture on its base and/or side surfaces (or walls). As such, a melted and cured polymer formed there can have the pattern and/or texture of the recess 246. This can allow a variety of 3D polymeric features to be created that have layered, digitized, wavy, or various other 3D visual effects.

In some examples, the recess 246 can comprise lower or bottom portions 252 that are shallower (or raised) relative to deeper portions of the recess 246 which may occur in a middle portion 254 of the recess 246 in some examples.

In some examples, a toe or forefoot portion 256 of the recess 246 can be shallower than other portions of the recess 246 (e.g., the middle portion 254).

In some examples, as shown in FIG. 11, the second mold portion 244 is the same as the first mold portion 242. However, in some examples, the second mold portion 244 can be different than the first mold portion 242 (e.g., having a recess 246 of a different size, depths, multiple cavities, and/or the like).

As shown in FIG. 11 and introduced above, a template 260 comprising openings 262 can be placed over the mold 240. The openings 262 are shaped and sized to match the shape and size of the recesses 246. A thickness of the template 260 is specified based on a desired thickness of the polymer material in the recesses 246. As such, the template 260 serves as a guide for filling the recesses 246 of the mold with polymer.

In some examples, the template 260 can comprise more openings, such as openings over the topline edge.

In some examples, a template may not be used.

At 206, the method includes filling the recesses and/or depressed edges of the mold with polymer material.

In some examples, the polymer material can comprise solid polymer in a form of pellets, granules, grains, shredded pieces, lumps, or the like. As used herein, a “solid polymer” can refer to a polymer in a solid state that is below it melting point temperature.

In some examples, the polymer material can comprise a thermoplastic material, such as thermoplastic polyurethane (TPU).

In some instances, TPU could provide enhanced bonding to the textile components described herein (such as a woven fabric), as compared to other thermoplastic materials.

In some examples, the polymer material can include one or more additives that enhance the aesthetic of and/or achieve a desired texture for the 3D polymeric feature. For example, additives may include one or more of glitter, sawdust, recycled polymer pieces, and/or the like.

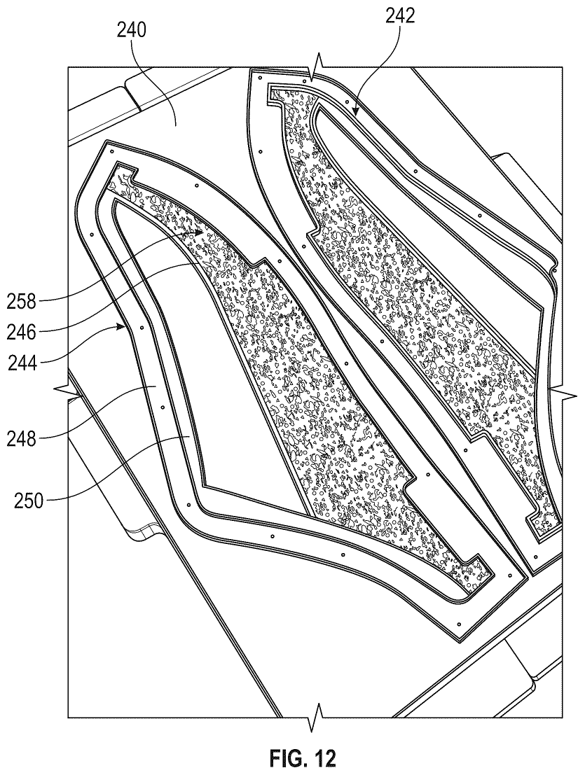

For example, as shown in FIG. 12, the recesses 246 are filled with polymer pellets 258. In some examples, additional regions of the mold 240 can be filled with polymer pellets, such as the topline edge 250 and/or outermost edge 248. The recesses 246 of the mold 240 can contain the greatest amount of the polymer pellets 258, as compared to the remaining regions of the mold 240.

At 208, the method includes forming the 3D polymeric feature(s) within the mold.

For example, the method at 208 can include removing the template from the mold (if used) and pressing the filled mold with the pressing apparatus to form the 3D polymeric feature(s) within the mold. In some examples, if a template is not used at 206, the method at 208 may not include removing the template from the mold.

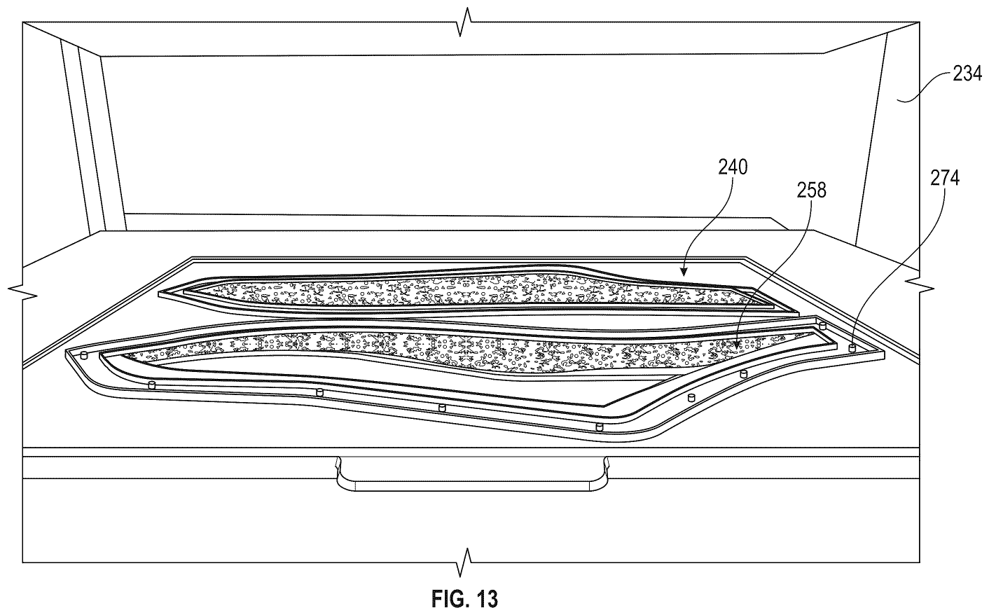

The method at 208 can include placing the filled mold into one or more pressing apparatuses (e.g., the mold 240 into the pressing apparatus 234, as shown in FIG. 13, and/or into the pressing apparatus 235) and actuating the pressing apparatus to press against the mold filled with the polymer material (e.g., polymer pellets 258).

In some examples, the pressing at 208 can include a heat press, followed by a cool press (e.g., two sequential pressing actions at different temperatures).

For example, as shown in FIG. 13, the filled mold 240 is arranged within the first pressing apparatus 234 (which can be referred to as the “heat press”) that is configured to be positioned against, and/or apply a pressing force to, the assembly. The pressing at 208 can include applying heat to the filled mold 240 with a top plate of the first pressing apparatus 234 that is at 70-90° C. and a bottom plate of the first pressing apparatus 234 that is at 170-190° C. The heat applied to the filled mold 240 can melt, or at least partially liquify, the polymer pellets 258 within the mold 240.

In some examples, pressure can be applied to the filled mold 240 with the first pressing apparatus 234 (with the plates at the temperatures described above) for about 60 seconds (e.g., +10 seconds) at 0 kg of pressure and then for about 110 seconds (e.g., +10 seconds) at 70 kg of pressure.

In some examples, the pressing at 208 can include arranging the mold 240 in the second pressing apparatus (e.g., second pressing apparatus 235) and pressing the filled mold 240 at a lower temperature than during the heat press. In some examples, the cooler press temperature can be in a range of 12-22° C. For example, the pressing at 208 at the cooler temperature can include applying the cooler temperature to the filled mold 240 with a top plate of the second pressing apparatus 235 that is at 12-22° C. and a bottom plate of the second pressing apparatus 235 that is at 12-22° C.

In some examples, during the cooler pressure operation, pressure can be applied to the filled mold 240 with the second pressing apparatus 235 (with the plates at the temperatures described above) for about 30 seconds (e.g., +10 seconds) at 50 kg of pressure.

In some examples, prior to the second, cooler pressing operation at 208, one or more silicone layers can be arranged over the melted polymer within the mold 240. In some examples, a silicone layer placed over the melted polymer and the mold 240 can comprise 5 mm silicone.

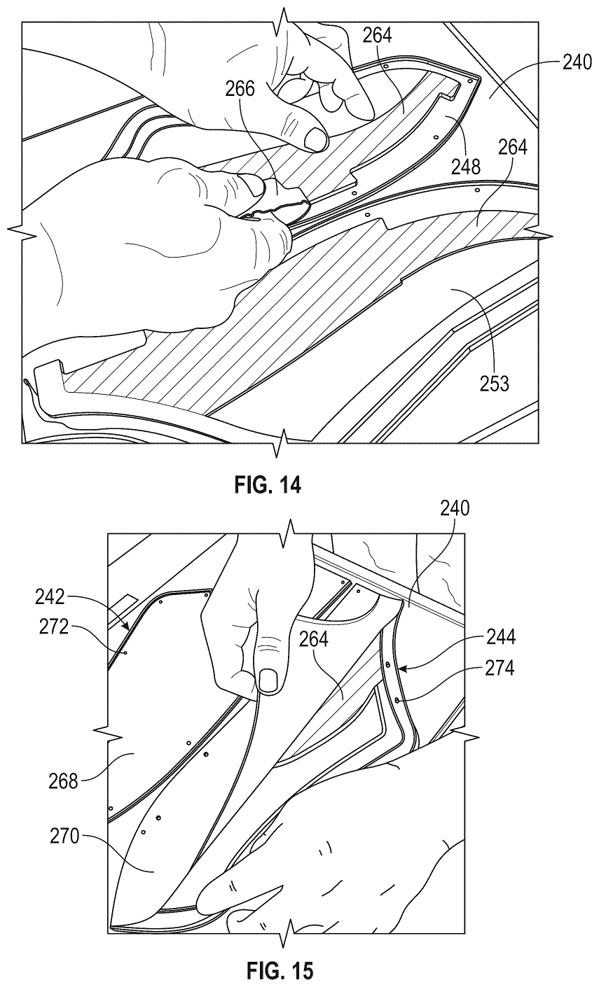

The pressing can melt the polymer within the mold 240, thereby molding the polymer within the mold and forming the 3D polymeric features. For example, as shown in FIG. 14, a 3D polymeric feature 264 is formed within the mold 240 (over/in the recess 246).

At 210, the method includes removing excess polymer material from around the 3D polymeric feature(s) within the mold. For example, the method at 210 can include removing the mold from the press to reveal a 3D polymeric feature that melted (or liquified) from the polymer pellets and then at least partially solidified within the recesses and over neighboring portions of the mold. Since some polymer may have flowed into other portions of the mold (e.g., depressed edge portions, such as the outermost edge 248 in FIGS. 11-14), this excess material that is outside of the 3D polymeric feature(s) can be peeled or cut away from around the 3D polymeric feature(s) inside the mold.

For example, as shown in FIG. 14, excess polymer 266 that flowed into and at least partially solidified inside the outermost edge 248 can peeled out of and away from the mold 240. After removing the excess polymer 266, only the 3D polymeric feature(s) 264 comprising the polymer remains inside the mold 240.

Due to the material of the mold 240 and/or the outermost edge 248 being recessed into the mold 240, the excess polymer can be easily removed (and thus can be referred to as having “releasable edges”).

In some examples, excess polymer can be removed from the inner cavity 253 of the mold 240.

At 212, the method includes bonding the 3D polymeric feature(s) to the prepared textile.

In some examples, the method at 212 can include arranging the textile (or textiles) over the mold such that the specified region of the textile configured to receive the 3D polymeric feature (i.e., the “no-sew” side or side surface) is placed directly over the 3D polymeric feature inside the mold.

In some examples, the textile can be coupled to the mold such that the textile does not shift during the bonding process.

For example, as shown in FIG. 15, a first textile 268 is arranged over the first mold portion 242 and a second textile 270 is arranged over the second mold portion 244. In some examples, as shown in FIG. 15, the first and second textiles 268, 270 can comprise apertures 272 that match up with and are arranged around corresponding pegs 274 of the mold 240. As a result, the first and second textiles 268, 270 can be prevented from shifting relative to the mold 240 during the pressing and bonding process.

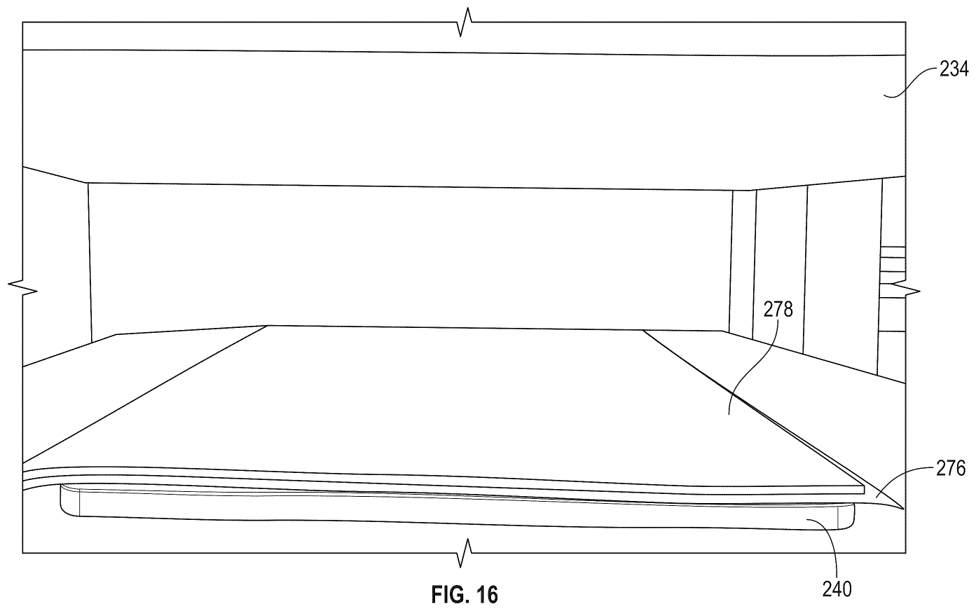

The method at 212 can further include placing the mold, with the textile(s) arranged over and/or coupled thereto, into the pressing apparatus (e.g., the mold 240 into the pressing apparatus 234, as shown in FIG. 16) and actuating the pressing apparatus to press against the textile(s) arranged over the 3D polymeric feature(s) inside the mold.

In some examples, the pressing at 212 can include a heat press, followed by a cool press (e.g., two sequential pressing actions at different temperatures).

For example, as shown in FIG. 16, the mold 240 with the textiles 268, 270 arranged over top are arranged within the first pressing apparatus 234 that is configured to apply a pressing force and heat to the assembly. The pressing at 212 can include applying heat to the textiles 268, 270 over the mold 240 with a top plate of the first pressing apparatus 234 that is at 175-195° C. and a bottom plate of the first pressing apparatus 234 that is at 110-130° C. The heat applied to the textiles 268, 270 and mold 240 can at least partially melt (or liquefy) the 3D polymeric features 264 within the mold 240 so that the 3D polymeric features 264 can adhere (and be transferred directly) to the textiles 268, 270.

In some examples, pressure can be applied to the filled mold 240 with the first pressing apparatus 234 (with the plates at the temperatures described above) for about 65 seconds (e.g., +10 seconds) at 40-60 kg of pressure.

In some examples, the pressing at 212 can include pressing together the textiles 268, 270 and the mold 240 a second time (e.g., with the second pressing apparatus 235), at a lower temperature than during the heat press. In some examples, the cooler press temperature can be in a range of 12-22° C. For example, the pressing at 212, for the cooler press, can include applying a cooler temperature to the textiles 268, 270 over the mold 240 with a top plate of the second pressing apparatus 235 that is at 12-22° C. and a bottom plate of the second pressing apparatus 235 that is at 12-22° C.

In some examples, during the cooler press operation, pressure can be applied to the filled mold 240 with the second pressing apparatus 235 (with the plates at the temperatures described above) for about 60 seconds (e.g., +10 seconds) at 20 kg of pressure.

In some examples, the temperature and pressing time during the cooler press can reduce the formation of air bubbles or other deformities within the 3D polymeric feature.

As a result, the 3D polymeric features 264 are bonded to and cured against the textiles 268, 270.

In some examples, prior to the first and/or second pressing operation at 212, one or more layers can be arranged over the textiles. For example, as shown in FIG. 16, a paper layer 276 can be arranged over the textiles 268, 270 and a silicone layer 278 can be arranged over the paper layer 276. In some examples, the silicone layer 278 has a thickness of approximately 3 mm.

The pressing at 212 bonds the 3D polymeric feature(s) to the textile(s), thereby creating one or more textiles with one or more 3D polymeric features bonding directly thereto, without stitching, adhesives, or the like.

At 214, the method includes removing the textile(s) with the 3D polymeric feature(s) bonded thereto from the mold. If desired, the textiles(s) can then me assembled to additional components to create all or a portion of a complete article (e.g., an upper for an article of footwear, a shirt, a glove, a hat, or the like).

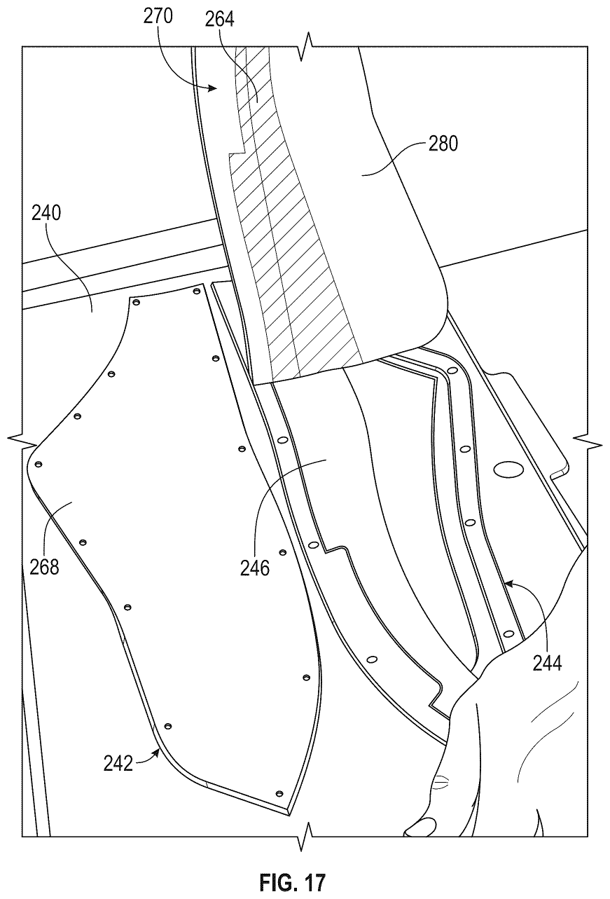

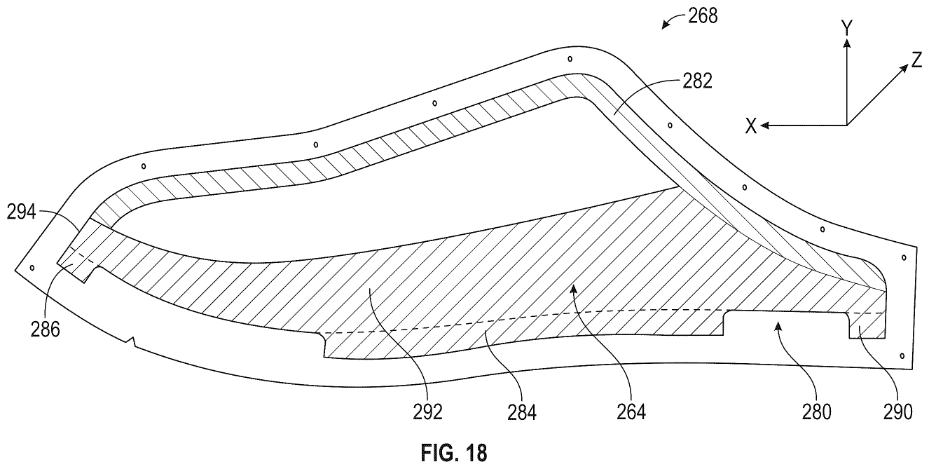

For example, as shown in FIG. 17, the second textile 270 is peeled away from the second mold portion 244 and the 3D polymeric feature 264 is bonded to a first surface 280 of the second textile 270.

Likewise, the first textile 268 can be peeled away from the first mold portion 242 to reveal the respective 3D polymeric feature 264 bonded to the respective first surface 280 of the first textile 268, as shown in FIG. 18.

In some examples, the first textile 268 can comprise the 3D polymeric feature 264 which can have varying thicknesses (in the negative z direction shown in FIG. 18, or out of the page) along its length (in the x direction) and/or height (in the y direction). Portions of the 3D polymeric feature 264 having a larger thickness (extending farther outward from the first surface 280 of the first textile 268) appear opaquer. As such, portions of the 3D polymeric feature that a relatively thinner (extend a smaller amount outward from the first surface 280) are less opaque (e.g., translucent or transparent in some instances). Thus, opacity of the 3D polymeric feature 264 increases with increasing thickness of the polymer material bonded to the first textile 268.

The 3D polymeric feature 264 can have varying patterns, thicknesses (or opacities), shapes, colors, finishes, textures, and/or the like along its length and/or height, such as those shown in FIGS. 2-6. For example, the 3D polymeric feature 264 can have any of the patterns shown in FIGS. 2-6, or various other patterns or combinations of patterns.

In some examples, the 3D polymeric feature 264 at and/or proximate to its first end 294, which may form a toe (and forefoot) region of the upper of the article of footwear, can be thinner than a majority of or adjacent portions of the 3D polymeric feature. This thinner region at or near to the first end 294 can enhance bonding of the 3D polymeric feature 264 to the textile 268 in this more highly mobile region of the upper formed from the textile 268.

In some examples, the first textile 268 can have a 3D polymeric feature 282 that is continuous with or separate from the 3D polymeric feature 264.

As shown in FIG. 18, the 3D polymeric feature 282 corresponds to the topline edge 250 of the mold 240. In some examples, the 3D polymeric feature 282 can extend along an eye stay region of the upper to be formed with the first textile 268 and second textile 270.

In some examples, the 3D polymeric feature 282 is thinner than at least a portion of the 3D polymeric feature 264.

In some examples, the first and second textiles 268, 270 may not include the 3D polymeric feature 282

In some examples, the 3D polymeric feature 264 can have thinner regions (e.g., that are thinner than thicker portions of the 3D polymeric feature 264) along its outer edges, such as a bottom flange 284 that may extend from a bite line of the upper to be formed, a toe flange 286 at a toe region at a first end of the 3D polymeric feature 264, and/or a heel flange 290 at a second end of the 3D polymeric feature 264.

Dashed lines in FIG. 18 represent approximate boundaries between the thinner flanges and a middle portion 292 of the 3D polymeric feature 264 that forms a majority of the 3D polymeric feature 264 and comprises varying patterns and shapes of varying thicknesses (and thus opacities), as described herein.

The cross-hatching in FIG. 18 represents the polymer material of the 3D polymeric feature, whereas the non-cross-hatched regions represent the material of the first textile 268.

In some examples, the first textile 268 and the second textile 270 can be assembled one or more additional textile components to form an upper (the first textile 268 and the second textile 270 forming medial and lateral sides thereof) of an article of footwear. For example, the material of the textile (e.g., fabric) that does not include the 3D polymeric features can be stitched to other layers or textiles components of the upper. The assembled upper can then be coupled to a midsole and/or outsole of the article.

In some examples, the pattern of thinner (less opaque) and thicker (more opaque) regions of the 3D polymeric feature 264 can correspond to thinner (or lower) and thicker (or higher) regions of the midsole, thereby creating an aesthetically pleasing and functional article of footwear that provides increased stability to the wearer.

In some examples, the bottom of the first textile 268 (and likewise, the second textile 270) and the bottom flange 284, toe flange 286, and heel flange 290 can curve underneath and be secured to a bottom or strobel of the upper, thereby providing a robust bonding margin between the first textile 268 and the strobel of the upper (at the bite line of the article). Further, when the upper is coupled to a sole structure, the flanges can extend from a bite line of the article of footwear to a ground-facing surface of the upper (or the strobel) that couples to the sole structure.

In some examples, the methods at 208-214 can be referred to as a flow molded polymer process. In some examples, when the polymer is TPU, the process can be referred to as a flow molded TPU (FMT) process.

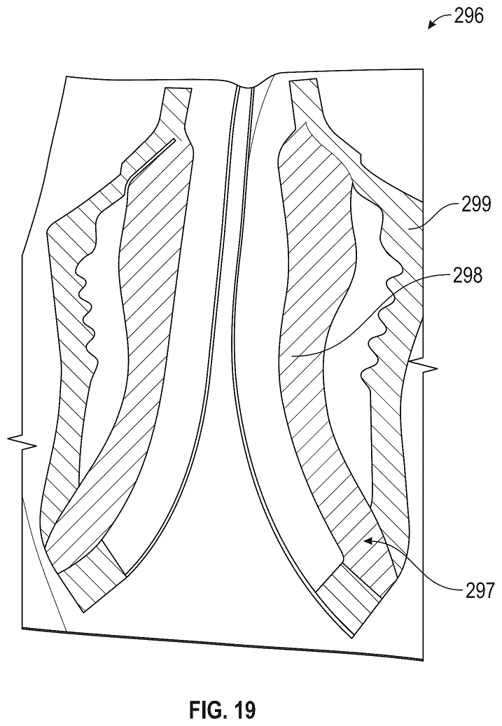

FIG. 19 presents an example of a textile 296 that can be created using the method 200, as described above with reference to FIG. 7. The textile 296 comprises a medial side and a lateral side for an upper of an article of footwear, where each of the medial and lateral sides comprise a 3D polymeric feature 297 bonded to the material of the textile 296. In FIG. 19, for purposes of illustration, the cross-hatched regions represent the 3D polymeric features and the non-cross-hatched regions represent the material (e.g., fabric material) of the textile 296.

Each 3D polymeric feature 297 can comprise a first portion 298 that has patterns of varying thickness (and thus opacities) along its length (e.g., from toe to heel) and a second portion 299 that forms a topline or eye stay region of the upper of the article. In some examples, the polymer of the second portion 299 is thinner than a majority of, or at least the thicker portions of the first portion 298.

Although the flange 284 is omitted in FIG. 19, in some examples, the flange 284 or a similar flange could be included as part of the 3D polymeric feature 297.

The methods described herein provide for a efficient way of forming 3D polymeric features and bonding them directly to textiles (without stitching or other fastening means). As such, textiles with 3D polymeric features can be created more easily and with an organic, smooth transition between the 3D polymeric feature and the surface of the textile to which it is bonded. This may provide more aesthetically pleasing features on a wearable textile that are durable (even during continuous movement). Further, by using a mold and the methods described herein to create the 3D polymeric features, a wide variety of 3D polymeric features having varying opacities, colors, textures, sizes, shapes, and/or the like can be created more easily. Further, different 3D polymeric features can be easily created in different zones of a same textile or article.

In some examples, the formed textiles having the 3D polymeric feature(s) bonded thereto can be attached to additional textile and/or non-textile components (such as a midsole or outsole for an article of footwear). For example, when the 3D polymeric features of a textile (such as an upper) are continuous with 3D features of additional components (such as a midsole), the resulting article (e.g., article of footwear) may provide increased stability and containment to a wearer. Further, an article of footwear including these components can comprise a more seamless upper and sole structure.

### Additional Examples of the Disclosed Technology

Additional examples of the disclosed technology are enumerated below.

Example 1. A method comprising filling one or more recesses of a mold with a polymer, wherein the one or more recesses comprise a first recess that is depressed into the mold and shaped and sized according to a 3D polymeric feature to be bonded to a textile; forming the 3D polymeric feature within the mold; and arranging the textile over the 3D polymeric feature within the mold and pressing the textile and mold together to bond the 3D polymeric feature directly to a surface of the textile, wherein the 3D polymeric feature extends outward from the surface of the textile.

Example 2. The method of any example herein, particularly example 1, wherein the pressing the textile and mold together includes applying heat to the textile and mold as they are pressed together.

Example 3. The method of any example herein, particularly example 2, wherein applying heat comprises applying heat to the textile over the mold with a top plate of a pressing apparatus that is at 175-195° C. and a bottom plate of the pressing apparatus 234 that is at 110-130, and wherein the textile and mold are arranged between the top plate and bottom plate.

Example 4. The method of any example herein, particularly either example 2 or example 3, wherein the pressing and applying heat is a first pressing operation, and wherein the pressing the textile and the mold together further includes pressing together the textile and mold a second time at a cooler temperature than during the first pressing operation.

Example 5. The method of any example herein, particularly example 4, wherein the cooler temperature is in a range of 12-22° C.

Example 6. The method of any example herein, particularly any one of examples 1-5, wherein the polymer is a solid polymer comprising a plurality of polymeric pellets.

Example 7. The method of any example herein, particularly any one of examples 1-6, wherein the polymer is thermoplastic polyurethane.

Example 8. The method of any example herein, particularly any one of examples 1-7, wherein forming the 3D polymeric feature within the mold includes applying pressure and heat to the mold such that the polymer melts within the first recess and forms the 3D polymeric feature within the mold.

Example 9. The method of any example herein, particularly example 8, wherein applying pressure and heat to the mold includes applying to the mold with a top plate of a pressing apparatus that is at 70-90° C. and a bottom plate of the pressing apparatus that is at 170-190° C.

Example 10. The method of any example herein, particularly example 8, wherein the forming the 3D polymeric feature further comprises, following the applying pressure and heat, applying pressure to the mold at a cooler temperature that is in a range of 12-22° C. to form the 3D polymeric feature within the mold.

Example 11. The method of any example herein, particularly any one of examples 1-10, wherein the mold comprises channels that are depressed into the mold, and further comprising removing excess polymer from the channels after forming the 3D polymeric feature within the mold and prior to arranging the textile over the 3D polymeric feature within the mold.

Example 12. The method of any example herein, particularly any one of examples 1-11, wherein the 3D polymeric feature has a varying thickness along its length such that first portions of the 3D polymeric feature extend further outward from the surface of the textile than second portions of the 3D polymeric feature, and wherein the varying thickness of the 3D polymeric feature corresponds with a varying depth of the first recess of the mold.

Example 13. The method of any example herein, particularly example 12, wherein the first portions have a greater opacity than the second portions.

Example 14. The method of any example herein, particularly any one of examples 1-13, wherein pressing the textile and mold together to bond the 3D polymeric feature directly to a surface of the textile includes bonding the 3D polymeric feature directly to fibers of the textile without sewing.

Example 15. The method of any example herein, particularly any one of examples 1-14, wherein the textile is a wearable textile.

Example 16. The method of any example herein, particularly any one of examples 1-15, wherein the textile forms at least a portion of an upper for an article of footwear, and further comprising assembling the textile to additional textile components to form the upper for the article of footwear; and assembling the formed upper to a sole structure of the article of footwear.

Example 17. The method of any example herein, particularly any one of examples 1-16, further comprising preparing the textile for bonding with the 3D polymeric feature, wherein preparing the textile includes pressing together two or more layers of material to form the textile, and wherein the pressing includes pressing at a first temperature and then at a second temperature, the second temperature lower than the first temperature.

Example 18. The method of any example herein, particularly example 17, wherein preparing the textile for bonding further comprises applying a coating that enhances bonding to a first surface of the textile that is configured to bond with the 3D polymeric feature.

Example 19. The method of any example herein, particularly any one of examples 1-18, wherein the textile comprises a woven fabric.

Example 20. An upper for an article of footwear, comprising a textile comprising a first side surface configured to bond with a polymeric material; and a 3D polymeric feature bonded directly to the first side surface without fasteners, wherein the 3D polymeric feature comprises at least a first portion with a first thickness and first opacity and a second portion with a second thickness and second opacity, wherein the first thickness and first opacity are greater than the second thickness and second opacity, and wherein the first and second thicknesses are defined in a direction extending outward and away from the first side surface of the textile.

Example 21. The upper of any example herein, particularly example 20, wherein the 3D polymeric feature comprises a plurality of first portions and second portions that alternate with one another along a length of the 3D polymeric feature, and wherein the length is defined in a toe-to-heel direction of the upper.

Example 22. The upper of any example herein, particularly either example 20 or example 21, wherein the 3D polymeric feature extends from a forefoot region to a heel region of the upper, and wherein the second portion is in the forefoot region.

Example 23. The upper of any example herein, particularly example 22, wherein the second thickness of the second portion is thinner than a remainder of the 3D polymeric feature.

Example 24. The upper of any example herein, particularly any one of examples 20-23, wherein the textile comprises a woven fabric.

Example 25. The upper of any example herein, particularly example 24, wherein the textile comprises a weave of two or more yarns, wherein a first yarn of the two or more yarns is a polyester filament, and wherein a second yarn of the two or more yarns is a spun or drawn textured yarn.

Example 26. The upper of any example herein, particularly any one of examples 20-25, wherein the 3D polymeric feature comprises TPU.

Example 27. The upper of any example herein, particularly any one of examples 20-26, wherein the upper comprises a strobel, and wherein the textile is coupled to the strobel such that a lower portion of the 3D polymeric feature wraps around to overlap a portion of the strobel.

Example 28. An article of footwear comprising the upper of any example herein, particularly any one of examples 20-27; and a sole structure, wherein the upper is coupled directly to the sole structure.

Example 29. The article of footwear of any example herein, particularly example 28, where the sole structure comprises a midsole.

Example 30. The article of footwear of any example herein, particularly either example 28 or example 29, wherein the 3D polymeric feature comprises a third portion forming a flange that extends away from a remainder of the 3D polymeric feature and is configured to extend from a bite line of the article of footwear to a ground-facing surface of the upper that couples to the sole structure.

Example 31. A method for forming an upper of an article of footwear comprising preparing a textile for the upper; filling one or more recesses of a mold with a solid polymer, wherein the one or more recesses comprise a first recess that is depressed into the mold and shaped and sized according to a 3D polymeric feature to be bonded to the prepared textile; forming the 3D polymeric feature within the first recess of the mold; bonding the 3D polymeric feature directly to a surface of the prepared textile; removing the textile from the mold, wherein the 3D polymeric feature extends outward from the surface of the textile; and assembling the textile with one or more additional components to form the upper.

Example 32. The method of any example herein, particularly example 31, wherein forming the 3D polymeric feature includes applying pressure and heat to the filled mold with a first pressing apparatus that comprises two opposing plates at temperatures in a range of 70-190° C., such that the solid polymer melts inside the first recess.

Example 33. The method of any example herein, particularly example 32, wherein forming the 3D polymeric feature includes applying pressure at a cooler temperature with a second pressure apparatus that comprises two opposing plates at temperature in a range of 12-22° C., such that the 3D polymeric feature at least partially solidifies and forms within the first recess.

Example 34. The method of any example herein, particularly any one of examples 31-33, wherein bonding the 3D polymeric feature to the prepared textile includes arranging the textile over the mold and pressing the textile and mold together with plates of a first pressing apparatus that are at temperatures in a range of 110-195° C.

Example 35. The method of any example herein, particularly example 34, wherein bonding the 3D polymeric feature to the prepared textile further comprises, following the pressing the textile and mold together with plates of the first pressing apparatus, pressing the textile and mold together with plates of a second pressing apparatus that are at a cooler temperature that is in a range of 12-22° C.

Example 36. The method of any example herein, particularly any one of examples 31-35, wherein the solid polymer comprises a plurality of polymeric pellets.

Example 37. The method of any example herein, particularly any one of examples 31-36, wherein the solid polymer is thermoplastic polyurethane.

Example 38. The method of any example herein, particularly any one of examples 31-37, further comprising removing excess polymer from around the formed 3D polymeric feature within the mold, prior to bonding the 3D polymeric feature directly to the prepared textile.

Example 39. The method of any example herein, particularly any one of examples 31-38, wherein the 3D polymeric feature has a varying thickness along its length such that first portions of the 3D polymeric feature extend further outward from the surface of the textile than second portions of the 3D polymeric feature, and wherein the varying thickness of the 3D polymeric feature corresponds with a varying depth of the first recess of the mold.

Example 40. The method of any example herein, particularly any one of examples 31-39, wherein preparing the textile of the upper includes pressing together two or more layers of material to form the textile, and wherein the pressing includes pressing at a first temperature and then at a second temperature, the second temperature lower than the first temperature.

Example 41. The method of any example herein, particularly any one of examples 31-40, wherein the textile comprises a woven fabric.

Example 42. The method of any example herein, particularly any one of examples 31-41, further comprising assembling the assembled upper to a sole structure of the article of footwear to form a complete article of footwear.

Example 43. The method of any example herein, particularly example 42, wherein the sole structure comprises a midsole.

Example 44. A wearable textile comprising a woven fabric with a first side surface configured to bond with a polymeric material; and a 3D polymeric feature bonded directly to the first side surface without fasteners, wherein the 3D polymeric feature comprises at least a first portion with a first thickness and first opacity and a second portion with a second thickness and second opacity, wherein the first thickness and first opacity are greater than the second thickness and second opacity, and wherein the first and second thicknesses are defined in a direction extending outward and away from the first side surface of the textile.

Example 45. The wearable textile of any example herein, particularly example 44, wherein the woven fabric is a woven polyester fabric.

Example 46. The wearable textile of any example herein, particularly either example 44 or example 45, wherein the woven fabric comprises a weave of two or more yarns, wherein a first yarn of the two or more yarns is a polyester filament, and wherein a second yarn of the two or more yarns is a spun or drawn textured yarn.

Example 47. The wearable textile of any example herein, particularly any one of examples 44-46, wherein the first side surface comprises a coating configured to enhance bonding between the woven fabric and the 3D polymeric feature.

Example 48. The wearable textile of any example herein, particularly any one of examples 44-47, wherein the 3D polymeric feature comprises a plurality of first portions and second portions that alternate with one another along a length of the 3D polymeric feature.

Example 49. The wearable textile of any example herein, particularly any one of examples 44-48, wherein the 3D polymeric feature comprises TPU.

Example 50. The wearable textile of any example herein, particularly any one of examples 44-49, wherein the wearable textile is one of an article of footwear, a glove, a jacket, a sport bra, a hat, a sock, or a shirt.

In view of the many possible examples to which the principles of the disclosed technology may be applied, it should be recognized that the illustrated examples are only preferred examples of the disclosed technology and should not be taken as limiting the scope of the claimed subject matter. Rather, the scope of the claimed subject matter is defined by the following claims and their equivalents.

1. A method comprising:
filling one or more recesses of a mold with a polymer, wherein the one or more recesses comprise a first recess that is depressed into the mold and shaped and sized according to a 3D polymeric feature to be bonded to a textile;
forming the 3D polymeric feature within the mold; and
arranging the textile over the 3D polymeric feature within the mold and pressing the textile and mold together to bond the 3D polymeric feature directly to a surface of the textile, wherein the 3D polymeric feature extends outward from the surface of the textile.

2. The method of claim 1, wherein the pressing the textile and mold together includes applying heat to the textile and mold as they are pressed together.

3. The method of claim 2, wherein applying heat comprises applying heat to the textile over the mold with a top plate of a pressing apparatus that is at 175-195° C. and a bottom plate of the pressing apparatus 234 that is at 110-130, and wherein the textile and mold are arranged between the top plate and bottom plate.

4. The method of claim 2, wherein the pressing and applying heat is a first pressing operation, and wherein the pressing the textile and the mold together further includes pressing together the textile and mold a second time at a cooler temperature than during the first pressing operation.

5. The method of claim 4, wherein the cooler temperature is in a range of 12-22° C.

6. The method of claim 1, wherein the polymer is a solid polymer comprising a plurality of polymeric pellets.

7. The method of claim 1, wherein forming the 3D polymeric feature within the mold includes applying pressure and heat to the mold such that the polymer melts within the first recess and forms the 3D polymeric feature within the mold.

8. The method of claim 7, wherein applying pressure and heat to the mold includes applying to the mold with a top plate of a pressing apparatus that is at 70-90° C. and a bottom plate of the pressing apparatus that is at 170-190° C.

9. The method of claim 7, wherein the forming the 3D polymeric feature further comprises, following the applying pressure and heat, applying pressure to the mold at a cooler temperature that is in a range of 12-22° C. to form the 3D polymeric feature within the mold.

10. The method of claim 1, wherein pressing the textile and mold together to bond the 3D polymeric feature directly to a surface of the textile includes bonding the 3D polymeric feature directly to fibers of the textile without sewing.

11. The method of claim 10, wherein preparing the textile for bonding further comprises applying a coating that enhances bonding to a first surface of the textile that is configured to bond with the 3D polymeric feature.

12. An upper for an article of footwear, comprising:
a textile comprising a first side surface configured to bond with a polymeric material; and
a 3D polymeric feature bonded directly to the first side surface without fasteners, wherein the 3D polymeric feature comprises at least a first portion with a first thickness and first opacity and a second portion with a second thickness and second opacity, wherein the first thickness and first opacity are greater than the second thickness and second opacity, and wherein the first and second thicknesses are defined in a direction extending outward and away from the first side surface of the textile.

13. The upper of claim 12, wherein the 3D polymeric feature comprises a plurality of first portions and second portions that alternate with one another along a length of the 3D polymeric feature, and wherein the length is defined in a toe-to-heel direction of the upper.

14. The upper of claim 12, wherein the 3D polymeric feature extends from a forefoot region to a heel region of the upper, and wherein the second portion is in the forefoot region.

15. The upper of claim 12, wherein the textile comprises a woven fabric.

16. The upper of claim 12, wherein the 3D polymeric feature comprises TPU.

17. The upper of claim 12, wherein the upper comprises a strobel, and wherein the textile is coupled to the strobel such that a lower portion of the 3D polymeric feature wraps around to overlap a portion of the strobel.

18. A method for forming an upper of an article of footwear comprising:
preparing a textile for the upper;
filling one or more recesses of a mold with a solid polymer, wherein the one or more recesses comprise a first recess that is depressed into the mold and shaped and sized according to a 3D polymeric feature to be bonded to the prepared textile;
forming the 3D polymeric feature within the first recess of the mold;
bonding the 3D polymeric feature directly to a surface of the prepared textile;
removing the textile from the mold, wherein the 3D polymeric feature extends outward from the surface of the textile; and
assembling the textile with one or more additional components to form the upper.

19. The method of claim 18, wherein bonding the 3D polymeric feature to the prepared textile includes:
arranging the textile over the mold and pressing the textile and mold together with plates of a first pressing apparatus that are at temperatures in a range of 110-195° C.; and
following the pressing the textile and mold together with plates of the first pressing apparatus, pressing the textile and mold together with plates of a second pressing apparatus that are at a cooler temperature that is in a range of 12-22° C.

20. The method of claim 18, further comprising assembling the assembled upper to a sole structure of the article of footwear to form a complete article of footwear.
